(19) United States
(12) Patent Application Publication
(10) Pub. No.: US 2024/0211278 A1
(43) Pub. Date: Jun. 27, 2024

(54) STORAGE DEVICE AND OPERATING METHOD THEREOF

(71) Applicant: Samsung Electronics Co., Ltd., Suwon-si (KR)

(72) Inventor: Jeangsu HWANG, Suwon-si (KR)

(73) Assignee: Samsung Electronics Co., Ltd., Suwon-si (KR)

(21) Appl. No.: 18/545,992

(22) Filed: Dec. 19, 2023

(30) Foreign Application Priority Data
Dec. 22, 2022 (KR) 10-2022-0182166

(51) Int. Cl. G06F 9/445; G06F 9/448

(52) U.S. Cl. CPC G06F 9/44526; G06F 9/448

(57) ABSTRACT

Provided is a storage device. The storage device is configured to communicate with a host according to a predetermined protocol, and includes at least one nonvolatile memory, and a memory controller configured to control a firmware load operation of the at least one nonvolatile memory, wherein the memory controller includes an execution region where main firmware and custom firmware in a form of an add-on to the main firmware are loaded, and is configured to receive a commit command from the host, and to load and execute the custom firmware in the execution region based on the commit command.

### CROSS-REFERENCE TO RELATED APPLICATION

This application is based on and claims priority under 35 U.S.C. § 119 to Korean Patent Application No. 10-2022-0182166, filed on Dec. 22, 2022, in the Korean Intellectual Property Office, the disclosure of which is incorporated by reference herein in its entirety.

### BACKGROUND

### 1. Field

Embodiments of the disclosure relate to a storage device, and more particularly, to a storage device for loading and executing custom firmware in the form of an add-on to main firmware in an execution area and an operating method thereof.

### 2. Description of Related Art

A representative example of a flash memory-based mass storage device is a solid state drive (SSD). With the explosive increase in demand for SSD, SSDs are widely used in various industries for diverse purposes.

A storage device may be driven through firmware. When the firmware is stored in the ROM of the storage device, it may be difficult to modify the firmware once the firmware is stored. Meanwhile, when the firmware is stored in the flash memory, the firmware stored in the storage device may be modified or updated.

During the product development process, firmware for main firmware test purposes may be developed, or firmware capable of changing the operation of the main firmware according to requirements of each firmware manufacturer may be developed. In this case, it is necessary to verify whether each firmware is valid, and since the main firmware needs to be modified, additional time and resources may be required.

### SUMMARY

Embodiments of the disclosure provide a storage device and an operating method thereof capable of reducing additional time and resources without modifying main firmware by verifying, loading, and executing custom firmware in the form of an add-on to the main firmware separately from the main firmware.

According to an aspect of the disclosure, there is provided a storage device configured to communicate with a host device, the storage device including: at least one nonvolatile memory: and a memory controller including an execution region, the memory controller configured to: control a firmware load operation of the at least one nonvolatile memory, receive a commit command from the host device, load custom firmware, which are configured in a form of an add-on to main firmware, into the execution region, and execute the custom firmware in the execution region based on the commit command.

According to another aspect of the disclosure, there is provided a method of operating a storage device including at least one nonvolatile memory, the method including: verifying a validity of custom firmware based on at least one of a checksum method, a hash function method, an electronic signature method, and a message authentication code (MAC) method: loading the custom firmware into an execution region based on a verification of the validity of the custom firmware: and executing the custom firmware loaded in the execution region.

According to another aspect of the disclosure, there is provided a host-storage system including: a host device configured to generate a firmware image download command and a commit command; and a storage device including at least one nonvolatile memory, wherein the storage device is configured to: receive the firmware image download command from the host device, determine whether to store custom firmware, which is configured in a form of an add-on to main firmware, in the nonvolatile memory based on the firmware image download command, receive the commit command from the host device, and load the custom firmware into an execution region of the storage device.

### BRIEF DESCRIPTION OF DRAWINGS

Embodiments will be more clearly understood from the following detailed description taken in conjunction with the accompanying drawings in which:

FIG. 1 is a block diagram illustrating a host-storage system according to an embodiment:

FIG. 2A is a diagram illustrating signal exchange between a host and a storage device according to a predetermined protocol according to an embodiment:

FIGS. 2B and 2C are tables for explaining a predetermined protocol according to an embodiment:

FIGS. 3A and 3B are block diagrams illustrating an implementation example of an execution region according to an embodiment:

FIG. 4 is a block diagram illustrating an implementation example of a host-storage system according to an embodiment:

FIG. 5 is a block diagram illustrating an implementation example of a host-storage system according to an embodiment:

FIG. 6 is a flowchart illustrating a method of operating a storage device, according to an embodiment:

FIG. 7 is a flowchart illustrating an implementation example of a method of operating a storage device, according to an embodiment:

FIG. 8 is a block diagram illustrating an electronic system according to an embodiment:

FIG. 9 is a block diagram illustrating a host-storage system according to an embodiment: and

FIG. 10 is a block diagram illustrating an example of applying a memory device according to example embodiments of the disclosure to a solid state drive (SSD) system.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the disclosure are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the disclosure.

It will be understood that when a component is referred to as being “connected to” another component, the component can be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. As used herein, expressions such as “at least one of” when preceding a list of elements, modify the entire list of elements and do not modify the individual elements of the list. For example, the expression, “at least one of a, b, and c” should be understood as including only a, only b, only c, both a and b, both a and c, both b and c, or all of a, b, and c.

Unless otherwise defined, all terms including technical or scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof will be omitted.

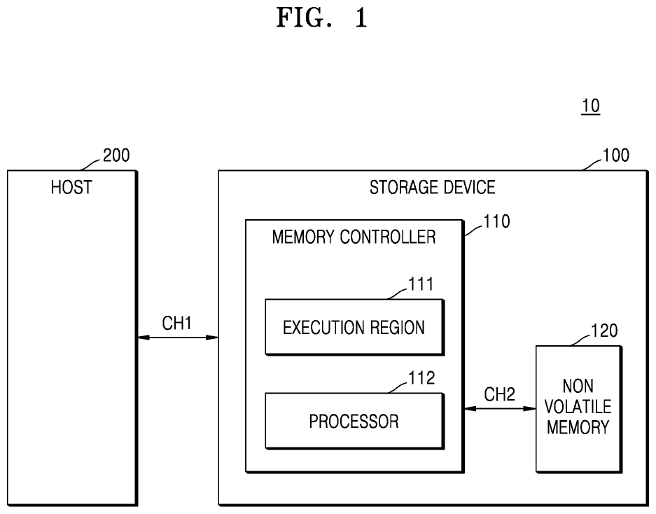

FIG. 1 is a block diagram illustrating a host-storage system 10 according to an embodiment.

The host-storage system 10, for example, may be implemented as a personal computer (PC), a data server, a network-coupled storage, an Internet of Things (IoT) device, or a portable electronic device. The portable electronic device may be a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, or the like.

Referring to FIG. 1, the host-storage system may include a storage device 100 and a host 200. The host 200 may communicate with the storage device 100 through a first channel CH1. According to an embodiment, the first channel CH1 may be a channel conforming to a nonvolatile memory express (NVMe) protocol. However, the disclosure is not limited thereto, and as such, according to another embodiment, the first channel CH1 may be a channel conforming to various protocols, such as peripheral component interconnection express (PCIe), peripheral component interconnection (PCI), universal flash storage (UFS), advanced technology attachment (ATA), and serial-ATA.

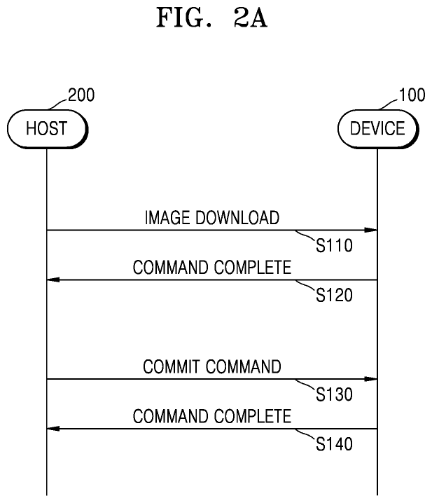

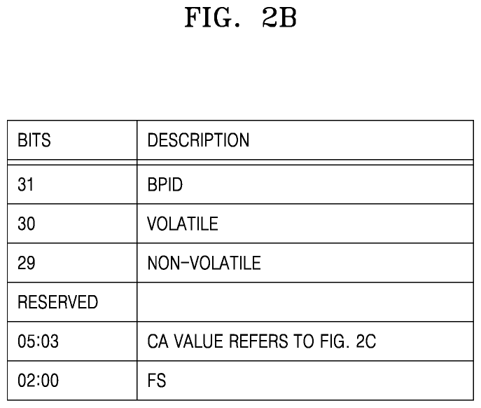

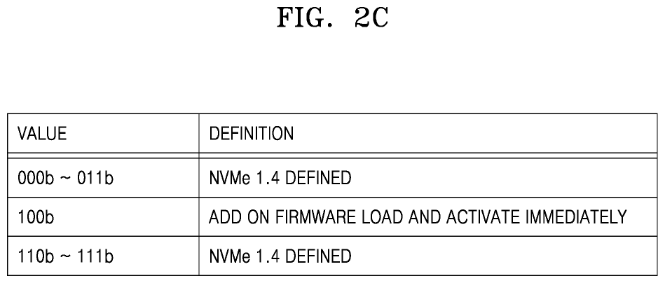

The host 200 may be configured to generate a firmware image download command and a commit command. For example, the host 200 may be configured to generate the firmware image download command and the commit command according to a predetermined protocol. FIGS. 2A to 2C illustrate an embodiment, in which, the host 200 generates the firmware image download command and the commit command.

The host 200 may include at least one requester. According to an embodiment, the requester may refer to a device or component generating a read command for a nonvolatile memory 120. For example, the requester may be a central processing unit (CPU) or graphics processing unit (GPU). However, the disclosure is not limited thereto, and as such, other electronic components and devices may be considered as the requester.

The storage device 100 may include a memory controller 110 and the nonvolatile memory 120, and the memory controller 110 may communicate with the nonvolatile memory 120 through a second channel CH2. According to an embodiment, the second channel CH2 may be similar to the first channel CH1, and as such, the second channel CH2 may be a channel conforming to various protocols.

The memory controller 110 may receive firmware from outside the storage device 100. For example, the memory controller 110 may receive firmware from an external device. Firmware is software included in a specific hardware device, and may refer to a device capable of reading, executing, or modifying software, and may refer to a kind of operating system responsible for controlling and driving hardware. According to an embodiment, the memory controller 110 may control the storage device 100 or internal hardware of the storage device 100 based on received firmware.

The firmware received by the memory controller 110 may be main firmware or custom firmware. The main firmware may be basic firmware that controls the storage device 100 or internal hardware of the storage device 100. The custom firmware may be firmware that supplements the main firmware, or may be firmware in the form of an add-on to the main firmware. The add-on type firmware may be referred to as plug-in type firmware, and may refer to firmware that adds a specific function to existing or main firmware. For example, the add-on type firmware may be any firmware additionally utilized in the storage device 100 or may be additionally installed by a user using the storage device 100.

According to an embodiment, the custom firmware may be firmware created for the purpose of testing the main firmware, and may be firmware required to change the operation of the main firmware according to requirements of each firmware manufacturer. For example, the custom firmware may include at least one of test firmware, dynamic thermal throttling (DTT) firmware, acceleration firmware, logging firmware, or debug firmware. However, the disclosure is not limited thereto, and as such, according to another embodiment, the custom firmware may include other types of firmware.

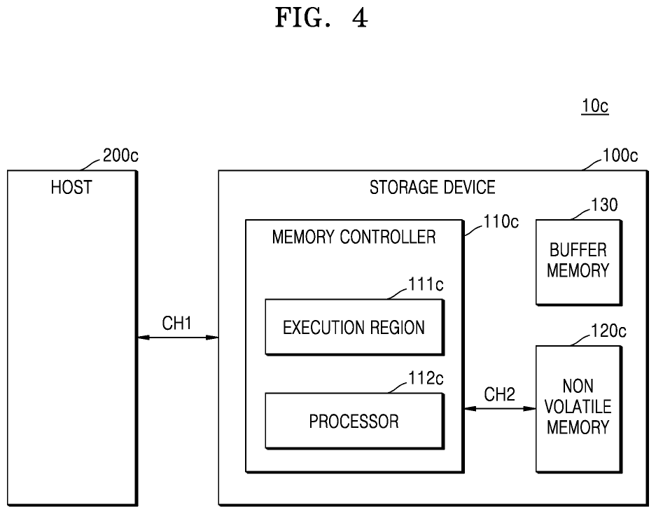

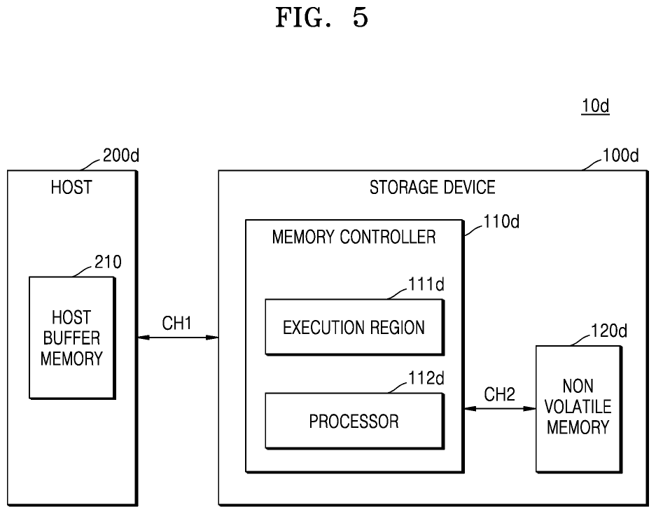

According to an embodiment, the host 200 may transmit a firmware image download command to the memory controller 110, and the memory controller 110 may receive custom firmware for a firmware image download command from a buffer memory included in the storage device 100. According to an embodiment, the host 200 may transmit the firmware image download command to the memory controller 110 according to the NVMe protocol. FIG. 4 illustrates an embodiment, in which, the memory controller 110 receives the custom firmware from the buffer memory included in the storage device 100. In addition, the host 200 may transmit a firmware image download command to the memory controller 110 according to the NVMe protocol, and the memory controller 110 may receive custom firmware for a firmware image download command from a host buffer memory included in the host 200. FIG. 5 illustrates an embodiment, in which, the memory controller 110 receives the custom firmware from the host buffer memory included in the host 200. Meanwhile, the firmware may be in the form of an image, and custom firmware received from a buffer memory included in the host 200 or the storage device 100 may be referred to as a custom firmware image. Hereinafter, custom firmware images are referred to as custom firmware.

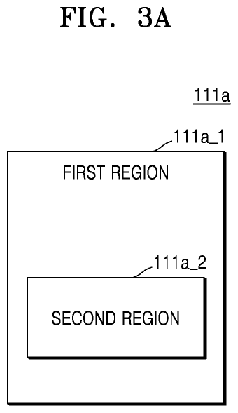

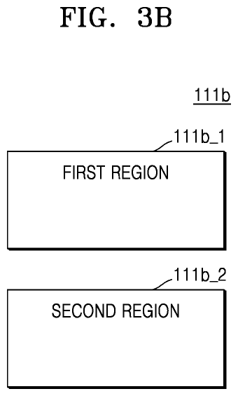

The memory controller 110 may include an execution region 111 and a processor 112. The execution region 111 may include a first area (or a first region) where main firmware is loaded and a second area (a second region) where custom firmware is loaded. Example embodiments of the first area and the second area are described below with reference to FIGS. 3A and 3B.

The processor 112 may receive a firmware image download command or a commit command from the host 200 and may control the memory controller 110 based on the firmware image download command or the commit command. The commit command may refer to a command for controlling a firmware-related operation of the storage device 100 and may include a commit action. The operation of the storage device 100 may vary depending on the type of commit action. For example, the commit action may be defined as an operation of loading custom firmware into the execution region 111 and an operation of executing the loaded custom firmware. According to an embodiment, the processor 112 may determine whether to store custom firmware in the nonvolatile memory 120 based on the firmware image download command. For example, when a firmware image download command includes a nonvolatile memory storage command, the processor 112 may store the custom firmware in the nonvolatile memory 120. The processor 112 may receive custom firmware from the nonvolatile memory 120 based on the commit command, load the received custom firmware into the execution region 111, and execute the loaded custom firmware. For example, if a one-time command is included in the firmware image download command, the processor 112 may not store the custom firmware in the nonvolatile memory 120. The processor 112 may load the execution region 111 based on the commit command and execute the loaded custom firmware.

A storage device according to the comparative example may not have an area for storing or executing custom firmware. For example, in the case of executing firmware created for the purpose of testing the main firmware or firmware required to change the operation of the main firmware according to the requirements of each firmware manufacturer, the storage device may receive a firmware update request and corresponding firmware from a host, and may update the main firmware in the storage device with the received firmware. Thereafter, the updated main firmware may be executed.

On the other hand, according to an embodiment, when firmware made for the purpose of testing the main firmware or firmware (hereinafter referred to as custom firmware) required to change the operation of the main firmware according to the requirements of each firmware manufacturer is executed, since the custom firmware, which is an add-on form of the main firmware, can be executed or updated without the need to update the main firmware as in the comparative example, the storage device 100 may receive necessary custom firmware from an area in the nonvolatile memory 120 designated for storing custom firmware. The storage device 100 may load the received custom firmware into the execution region 111 and execute the loaded custom firmware based on the commit command received from the host 200.

That is, since the storage device 100 includes an area for storing custom firmware (e.g., the nonvolatile memory 120) or an area for executing custom firmware (e.g., the execution region 111), the custom firmware may be configured (or composed) in the form of an add-on to the main firmware, so that additional time required for updating the main firmware may not be necessary. Thus, additional time and additional resources required by the storage device of the comparative example may be reduced.

The memory controller 110 may include a firmware verifier that verifies firmware. The firmware verifier may check the firmware for corruption. For example, the firmware verifier may perform an integrity check or validation. As an example of the integrity check, a checksum method, a hash function method, an electronic signature method, or a Message Authentication Code (MAC) method may be used. The type of verification is not limited thereto. According to an embodiment, the firmware verifier may validate custom firmware received by the memory controller 110 from the host 200 or a buffer memory included in the storage device 100.

The nonvolatile memory 120 may include nonvolatile memory, such as NAND Flash Memory, Vertical NAND Flash Memory, NOR Flash Memory, Resistive Random Access Memory, Phase-Change Memory, Magnetoresistive Random Access Memory, and the like.

The nonvolatile memory 120 may include a memory cell array (MCA), and the MCA may include a plurality of memory blocks. Also, each memory block may include a plurality of word lines and one or more dummy word lines. For example, memory cells connected to each word line may constitute one page, and user data may be stored in a page corresponding to a plurality of word lines, but no data may be stored in a page corresponding to one or more dummy word lines.

The nonvolatile memory 120 may include an area in which firmware is stored. For example, the nonvolatile memory 120 may include an area where main firmware is stored and an area where custom firmware is stored. When the processor 112 includes a nonvolatile memory storage command in the firmware image download command received from the host 200, the processor 112 may store the custom firmware in an area where the custom firmware is stored inside the nonvolatile memory 120.

FIG. 2A is a diagram illustrating signal exchange between a host and a storage device according to an embodiment. As shown in FIG. 2A, the signal exchange between the host and the storage device may include a plurality of operations S110 to S140. According to an embodiment, the signal exchange between the host and the storage device may be according to a predetermined protocol. Referring further to FIG. 1, the host 200 and the storage device 100 of FIG. 2A may respectively be the same as the host 200 and the storage device 100 of FIG. 1, respectively, and repeated descriptions as those of FIG. 1 are omitted.

In operation S110, the host 200 may transmit a firmware image download command (or a firmware image download request, hereinafter referred to as a firmware image download command) to the storage device 100. According to an embodiment, the host 200 may be configured to generate a firmware image download command according to a predetermined protocol (e.g., the NVMe protocol). For example, the firmware image download command may include a custom firmware download command, and the memory controller 110 in the storage device 100 may receive custom firmware for a firmware image download command from a host buffer memory inside the host 200 or a buffer memory inside the storage device 100 based on the firmware image download command. However, the disclosure is not limited thereto, and as such, according to another embodiment, the memory controller 110 in the storage device 100 may receive custom firmware from another element in the host 200 or the storage device 100.

According to an embodiment, the firmware image download command may include a nonvolatile memory storage command or a one-time command as illustrated with reference to FIG. 2B.

In operation S120, the storage device 100 may transmit an operation completion signal for a firmware image download command to the host 200. According to an embodiment, the storage device 100 may transmit a custom firmware download operation completion signal to the host 200 after performing a custom firmware download operation based on a firmware image download command. For example, after completing an operation of downloading the custom firmware received from the host buffer memory inside the host 200 or the buffer memory inside the storage device 100, the storage device 100 may transmit an operation completion signal to the host 200 to perform an operation. According to an embodiment, the host buffer memory being inside the host 200 indicates that the host buffer memory is physically located inside the host 200 and the buffer memory being inside the storage device 100 indicates that the buffer memory is physically located inside the storage device 100. However, the disclosure is not limited to this configuration for downloading the custom firmware.

According to an embodiment, the storage device 100 may perform a custom firmware verification operation before performing a custom firmware download operation. For example, the storage device 100 may include a firmware verifier, and the firmware verifier may perform validation of custom firmware received from the host buffer memory inside the host 200 or the buffer memory inside the storage device 100. After validating the custom firmware, the storage device 100 may perform a custom firmware download operation and transmit an operation completion signal to the host 200.

In operation S130, the host 200 may transmit a commit command to the storage device 100. According to an embodiment, the host 200 may be configured to generate a commit command according to a predefined protocol (e.g., the NVMe protocol). For example, the commit command may include a command to perform an operation of loading the custom firmware into the execution region 111 and an operation of executing the loaded custom firmware.

In operation S140, the storage device 100 may transmit to the host 200 an operation completion signal based on the commit command from the host 200. For example, the storage device 100 may transmit to the host 200 the operation completion signal in response to the commit command from the host 200. According to an embodiment, the storage device 100 may transmit an operation completion signal to the host 200 after performing a custom firmware load operation and execution operation based on a commit command. For example, the storage device 100 may load custom firmware received from a host buffer memory inside the host 200 or a buffer memory inside the storage device 100 into the execution region 111 based on a commit command, and execute the custom firmware loaded into the execution region 111. After executing the custom firmware, an operation completion signal may be transmitted to the host 200.

FIGS. 2B and 2C are tables for explaining a predetermined protocol according to an embodiment.

Referring to FIG. 2B, the table of FIG. 2B may represent a portion of a firmware image download command according to a predetermined NVMe protocol. Parts other than bits 30 and Bits 29 may refer to a previously determined NVMe protocol, and bits 30 and bits 29 may refer to additional options for custom firmware. Although bits 30 and 29 are illustrated in FIG. 2B, referring to additional options for custom firmware, the disclosure is not limited thereto, and as such, according to another embodiment, other part of the NVMe protocol or another protocol may be used to indicate the additional options for custom firmware.

According to an embodiment, bits 30 may be set as a volatile attribute, and the volatile attribute may refer to that the storage device 100 uses custom firmware once without storing the custom firmware. Volatile attributes may be referred to as one-time commands. For example, when a user using the storage device 100 uses custom firmware to be added to the storage device 100 on a one-time basis, a firmware image download command received by the storage device 100 may include a volatile attribute (or one-time command). The storage device 100 may load and execute the custom firmware in the execution region 111 based on a commit command without storing the custom firmware in the nonvolatile memory 120 based on a volatile attribute (or one-time command).

According to an embodiment, bits 29 may be set to a Non-Volatile attribute, and the non-volatile attribute may refer to that the storage device 100 stores the custom firmware in the nonvolatile memory 120 and uses the custom firmware later. Non-Volatile attributes may be referred to as nonvolatile memory storage commands. For example, when a user using the storage device 100 uses custom firmware to be added to the storage device 100 multiple times, the firmware image download command received by the storage device 100 may include a non-volatile attribute (or a nonvolatile memory storage command). The storage device 100 may store custom firmware in the nonvolatile memory 120 based on non-volatile attributes (or nonvolatile memory storage commands), and load and execute custom firmware stored in the nonvolatile memory 120 in the execution region 111 based on the commit command.

According to an embodiment, the custom firmware may be used once or multiple times depending on the user who uses the storage device 100, and in the case of multi-use, the custom firmware is stored in the nonvolatile memory 120 so that the custom firmware may be executed like the main firmware.

Referring to FIG. 2C, the table of FIG. 2C may represent part of a commit command according to a predetermined NVMe protocol. The commit command may include a commit action, and the operation of the storage device 100 may vary depending on the type of the commit action.

According to an embodiment, the values defined in 000b to 011b may refer to values defined in NVMe version 1.4, and the values defined in 110b to 111b may refer to values defined in NVMe version 1.4. A value defined in 100b may refer to a value defined for custom firmware. The custom firmware may be add-on firmware to the main firmware and may be referred to as add-on firmware. For example, the value defined in 100b may be defined as an add-on firmware (or custom firmware) load operation and an immediate activation operation. The storage device 100 may load the custom firmware received from the host buffer memory inside the host 200 or the buffer memory inside the storage device 100 into the execution region 111 based on the commit command, and execute the loaded custom firmware on a one-time basis. The storage device 100 may load the custom firmware received from the nonvolatile memory 120 into the execution region 111 based on the commit command and execute the loaded custom firmware multiple times.

FIGS. 3A and 3B are block diagrams illustrating an implementation example of an execution region according to an embodiment. An execution region 111a of FIG. 3A or an execution region 111b of FIG. 3B may be an implementation example of the execution region 111 of FIG. 1, and duplicate descriptions as those of FIG. 1 are omitted.

According to an embodiment, referring to FIGS. 1 and 3A, the execution region 111a may include a first region 111a_1 in which main firmware is loaded and a second region 111a_2 in which custom firmware is loaded, and the first region 111a_1 may include the second region 111a_2. For example, the second region 111a_2 may be an empty region in the first region 111a_1. The storage device 100 may load the received custom firmware into the second region 111a_2 based on the commit command and execute the loaded custom firmware.

According to an embodiment, referring to FIGS. 1 and 3B, the execution region 111b may include a first region 111b_1 in which main firmware is loaded and a second region 111b_2 in which custom firmware is loaded, and the first region 111b_1 may be distinguished from the second region 111b_2. For example, the second region 111b_2 may be located in a separate space from the first region 111b_1, or the second region 111b_2 may be overlaid on the first region 111b_1. The storage device 100 may load the received custom firmware into the second region 111b_2 based on the commit command and execute the loaded custom firmware.

According to an embodiment, in case of executing custom firmware according to a need of the user, since custom firmware is loaded without updating the main firmware, from a region other than the region where the main firmware is loaded, additional time required for updating may be reduced, and additional resources required for firmware management and maintenance may be reduced.

FIG. 4 is a block diagram illustrating an implementation example of a host-storage system according to an embodiment. According to an embodiment, a host-storage system 10c of FIG. 4 may be an example of the host-storage system 10 of FIG. 1.

Referring to FIGS. 1 and 4, the host-storage system 10c may include a storage device 100c and a host 200c, and the storage device 100c may include a memory controller 110c, a nonvolatile memory 120c, and a buffer memory 130. According to an embodiment, the memory controller 110c, the execution region 111c and the processor 112c that may be included in the memory controller 110c, the host 200c, and the nonvolatile memory 120c of FIG. 4 may be the same as the memory controller 110, the execution region 111, the processor 112, the host 200, and the nonvolatile memory 120 of FIG. 1, respectively. Descriptions that are the same as those of FIG. 1 are omitted.

The buffer memory 130 may store custom firmware and transmit the custom firmware to the memory controller 110c. The custom firmware may be firmware created for the purpose of testing the main firmware, and may be firmware required to change the operation of the main firmware according to requirements of each firmware manufacturer. For example, the custom firmware may include at least one of test firmware, DTT firmware, acceleration firmware, logging firmware, or debug firmware.

According to an embodiment, the host 200c may transmit a firmware image download command to the memory controller 110c according to the NVMe protocol, and the memory controller 110c may receive custom firmware for a firmware image download command from the buffer memory 130. For example, when the firmware image download command received by the memory controller 110c includes a request to perform a download operation of test firmware created for the purpose of testing the main firmware as custom firmware, the memory controller 110c may receive test firmware from the buffer memory 130. Subsequent operations may be the same as those described above with reference to FIGS. 1 and 2A.

FIG. 5 is a block diagram illustrating an implementation example of a host-storage system according to an embodiment. According to an embodiment, a host-storage system 10d of FIG. 5 may be an example of the host-storage system 10 of FIG. 1.

Referring to FIGS. 1 and 5, the host-storage system 10d may include a storage device 100d and a host 200d, and the host 200d may include a host buffer memory 210. The storage device 100d may include a memory controller 110d and a nonvolatile memory 120d. According to an embodiment, the memory controller 110d, the execution region 111d and the processor 112d that may be included in the memory controller 110d, the host 200d, and the nonvolatile memory 120d of FIG. 5 may be the same as the memory controller 110, the execution region 111, the processor 112, the host 200, and the nonvolatile memory 120 of FIG. 1, respectively. Descriptions that are the same as those of FIG. 1 are omitted.

The host buffer memory 210 may store custom firmware and transmit the custom firmware to the memory controller 110d. The custom firmware may be firmware created for the purpose of testing the main firmware, and may be firmware required to change the operation of the main firmware according to requirements of each firmware manufacturer. For example, the custom firmware may include at least one of test firmware, DTT firmware, acceleration firmware, logging firmware, or debug firmware.

According to an embodiment, the host 200d may transmit a firmware image download command to the memory controller 110d according to the NVMe protocol, and the memory controller 110d may receive custom firmware for a firmware image download command from the host buffer memory 210. For example, when the memory controller 110d receives a request to perform a download operation as custom firmware necessary for changing the operation of the main firmware according to the requirements of each firmware manufacturer, the memory controller 110d may receive custom firmware from the host buffer memory 130. Subsequent operations may be the same as those described above with reference to FIGS. 1 and 2A.

According to an embodiment, the host 200d may store the firmware image download command in a submission queue of the host 200d. In this case, custom firmware for the firmware image download command may be stored in the submission queue together with the firmware image download command. The storage device 100d may acquire custom firmware based on information stored in the submission queue. The host 200d may transmit the custom firmware to the storage device 100d in various ways, and the transmission method is not limited thereto.

According to an embodiment, the custom firmware may be stored in the host buffer memory 210 outside the storage device 100d instead of the storage device 100d, and the custom firmware may be loaded and executed from the host buffer memory 210. Accordingly, the memory of the storage device 100d may be used more efficiently than when custom firmware is stored in the storage device 100d.

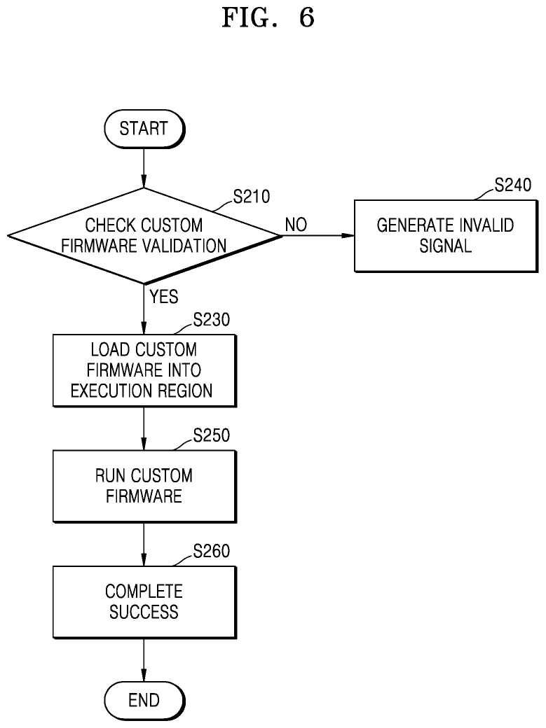

FIG. 6 is a flowchart illustrating a method of operating a storage device, according to an embodiment. As shown in FIG. 6, the method of operating the storage device may include a plurality of operations S210 to S260.

Referring to FIGS. 1 and 6, in operation S210, the memory controller 110 may verify the validity of the received custom firmware. According to an embodiment, the memory controller 110 may receive custom firmware from a host buffer memory inside the host 200 or a buffer memory inside the storage device 100, and validate the received custom firmware. For example, the memory controller 110 may verify the validity of the received custom firmware.

In operation S240, the memory controller 110 may generate an invalid signal when the received custom firmware is not valid. According to an embodiment, when the received custom firmware is not valid, the memory controller 110 may generate an invalid signal and transmit the invalid signal to the host 200. When receiving an invalid signal, the host 200 may perform an operation for transmitting valid custom firmware.

In operation S230, the memory controller 110 may load the custom firmware into the execution region 111 if the received custom firmware is valid. According to an embodiment, the host 200 may transmit a commit command to the memory controller 110 according to a predetermined protocol (e.g., the NVMe protocol). The commit command may include a commit action, and the commit action may be defined as an operation in which the memory controller 110 loads the custom firmware into the execution region 111. The memory controller 110 may load the received custom firmware into the execution region 111 based on the commit command.

In operation S250, the memory controller 110 may execute the loaded custom firmware. According to an embodiment, a commit command generated by the host 200 may include a commit action, and the commit action may be defined as an operation of executing custom firmware loaded in the execution region 111. The storage device 100 may execute the loaded custom firmware based on a commit command.

In operation S270, the storage device 100 may transmit an operation completion signal in response to the commit command to the host 200. According to an embodiment, the storage device 100 may transmit an operation completion signal to the host 200 after performing a custom firmware load operation and execution operation based on a commit command.

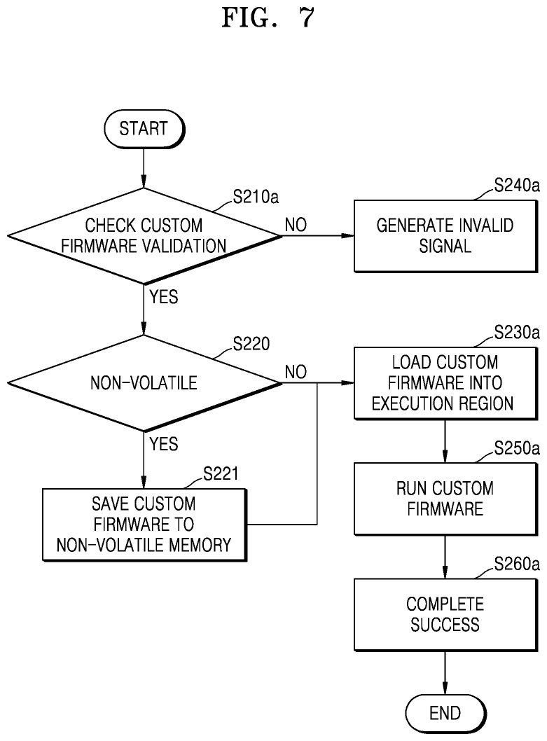

FIG. 7 is a flowchart illustrating an implementation example of a method of operating a storage device, according to an embodiment. As shown in FIG. 7, the method of operating the storage device may include a plurality of operations S210a to S260a. According to an embodiment, the method of operating the storage device of FIG. 7 may be an example of the method of operating the storage device of FIG. 6.

Referring to FIGS. 6 and 7, according to an embodiment, operations S210a, S240a, S250a and S260a of FIG. 7 may be respectively identical to operations S210, S240, S250 and S260 of FIG. 6. Descriptions that are the same as those of FIG. 6 are omitted.

In operation S220, the memory controller 110 may determine whether to store the received custom firmware in the nonvolatile memory 120 based on the firmware image download command. According to an embodiment, when a user using the storage device 100 uses custom firmware to be added to the storage device 100 once, the firmware image download command received by the storage device 100 may include a one-time command. The storage device 100 may not store custom firmware in the nonvolatile memory 120 based on a one-time command.

According to an embodiment, when a user using the storage device 100 uses custom firmware to be added to the storage device 100 multiple times, the firmware image download command received by the storage device 100 may include a nonvolatile memory storage command. In operation S221, the storage device 100 may store the custom firmware in the nonvolatile memory 120 based on the nonvolatile memory storage command.

When the memory controller 110 does not store the custom firmware in the nonvolatile memory 120 in operation S230a, the memory controller 110 may operate in the same manner as in operation S230 of FIG. 6.

When the memory controller 110 stores the custom firmware in the nonvolatile memory 120 in operation S230a, the memory controller 110 may receive custom firmware from the nonvolatile memory 120 and load the custom firmware into the execution region 111 based on a commit command. According to an embodiment, the host 200 may transmit a commit command to the memory controller 110 according to a predetermined protocol (e.g., the NVMe protocol). The commit command may include a commit action, and the commit action may be defined as an operation in which the memory controller 110 loads the custom firmware into the execution region 111. The memory controller 110 may receive custom firmware from the nonvolatile memory 120 and load the custom firmware into the execution region 111 based on a commit command.

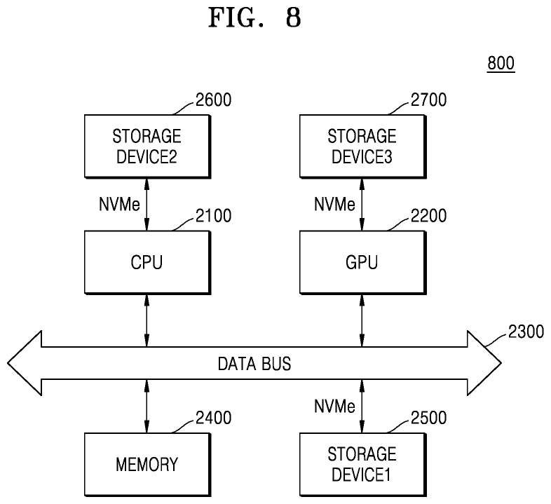

FIG. 8 is a block diagram illustrating an electronic system 800 according to an embodiment.

The electronic system of FIG. 8 may include a CPU 2100, a GPU 2200, a data bus 2300, a memory 2400, a first storage device 2500, a second storage device 2600, and a third storage device 2700.

The CPU 2100 may control the overall operation of the electronic system, and more specifically, the operation of other components constituting the electronic system. The CPU 2100 may be implemented as a general-purpose processor, a dedicated processor, or an application processor.

The GPU 2200 may refer to a processor that performs graphic processing, simulation, image processing, deep learning, and the like of an electronic system. Like the CPU 2100, the GPU 2200 may be implemented as a general-purpose processor, a dedicated processor, or an application processor.

The data bus 2300 may refer to a transmission path for transmitting and receiving data between components of an electronic system. The memory 2400 may be used as a main memory device of an electronic system.

The first storage device 2500 may communicate according to the NVMe protocol through the data bus 2300. For example, the first storage device 2500 may receive a firmware image download command or a commit command from a requester, such as the CPU 2100 or the GPU 2200, through the data bus 2300.

Unlike the first storage device 2500, the second storage device 2600 or the third storage device 2700 may be directly connected to the CPU 2100 or the GPU 2200 through the NVMe protocol. For example, the second storage device 2600 may be directly connected to the CPU 2100 through an NVMe protocol and may receive a firmware image download command or a commit command from the CPU 2100. The third storage device 2700 may be directly connected to the GPU 2200 through the NVMe protocol, and may receive a firmware image download command or a commit command from the GPU 2200.

In embodiments of the inventive concept, it has been described that each of the first, second, and third storage devices 2500, 2600, and 2700 communicates with the data bus 2300, the CPU 2100, or the GPU 2200 through the NVMe protocol, but is not limited thereto. For example, the first, second, and third storage devices 2500, 2600, and 2700 may be connected to a server, and communication between the server and a storage device may be possible through an NVME over Fabrics (NVMe-oF) protocol.

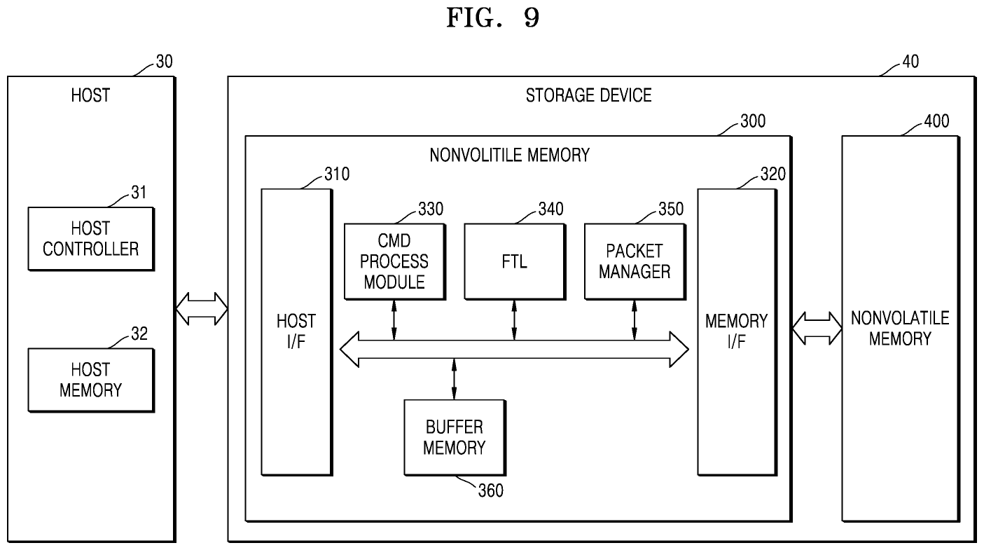

FIG. 9 is a block diagram illustrating a host-storage system according to an embodiment.

The host-storage system may include a host 30 and a storage device 40. Also, the storage device 40 may include a storage controller 300 and a nonvolatile memory 400. Also, according to an embodiment, the host 30 may include a host controller 31 and a host memory 32. The host memory 32 may function as a buffer memory for temporarily storing data to be transmitted to the storage device 40 or data transmitted from the storage device 40. For example, the host memory 32 may store custom firmware and transmit the custom firmware to the storage device 40.

The storage device 40 may include storage media for storing data according to a request from the host 30. As an example, the storage device 40 may include at least one of an SSD, an embedded memory, and a removable external memory. When the storage device 40 is an SSD, the storage device 40 may be a device complying with PCIe or NVMe standards. If the storage device 40 is an embedded memory or an external memory, the storage device 40 may be a device conforming to UFS or embedded multi-media card (eMMC) standards. The host 30 and the storage device 40 may generate and transmit a packet according to an adopted standard protocol, respectively.

When the nonvolatile memory 400 of the storage device 40 includes a flash memory, the flash memory may include a 2D NAND memory array or a 3D (or vertical) NAND memory array. As another example, the storage device 40 may include other various types of nonvolatile memories. For example, the storage device 40 may include magnetic RAM (MRAM), spin-transfer torque MRAM, conductive bridging RAM (CBRAM), ferroelectric RAM (FeRAM), Phase RAM (PRAM), a resistive RAM, and other various types of memory.

According to an embodiment, the host controller 31 and the host memory 32 may be implemented as separate semiconductor chips. Alternatively, According to an embodiment, the host controller 31 and the host memory 32 may be integrated on the same semiconductor chip. As an example, the host controller 31 may be any one of a plurality of modules included in an application processor, and the application processor may be implemented as a system on chip (SoC). In addition, the host memory 32 may be an embedded memory provided in the application processor or a nonvolatile memory or memory module disposed outside the application processor.

The host controller 31 may manage an operation of storing buffer area data (e.g., write data) in the nonvolatile memory 400 or storing data (e.g., read data) of the nonvolatile memory 400 in the buffer area.

The storage controller 300 may include a host interface 310, a memory interface 320, and a command process module 330. In addition, the storage controller 300 may further include a flash translation layer (FTL) 340, a packet manager 350, a buffer memory 360, and a command process module 330. The storage controller 300 may further include a working memory into which the FTL 340 is loaded, and when the command process module 330 executes the flash conversion layer 340, data writing and reading operations for the nonvolatile memory 400 may be controlled. Also, a firmware image download command or a commit command may be received from the host 30, and based on this, a custom firmware load operation and execution operation may be performed.

The host interface 310 may transmit and receive packets to and from the host 30. A packet transmitted from the host 30 to the host interface 310 may include a command or data to be stored in the nonvolatile memory 400, and a packet transmitted from the host interface 310 to the host 30 may include a response to a command or data read from the nonvolatile memory 400. The memory interface 320 may transmit data to be written in the nonvolatile memory 400 to the nonvolatile memory 400 or may receive data read from the nonvolatile memory 400. This memory interface 320 may be implemented to comply with standard protocols such as Toggle or Open NAND Flash Interface (ONFI).

The FTL 340 may perform various functions such as address mapping, wear-leveling, and garbage collection. The address mapping operation is an operation of changing a logical address received from the host 30 into a physical address used to actually store data in the nonvolatile memory 400. The wear-leveling is a technique for preventing excessive deterioration of a specific block by allowing blocks in the nonvolatile memory 400 to be used uniformly, and for example, may be implemented through a firmware technique that balances erase counts of physical blocks. The garbage collection is a technique for securing usable capacity in the nonvolatile memory 400 by copying valid data of a block to a new block and then erasing an existing block.

The packet manager 350 may generate a packet according to the protocol of the interface negotiated with the host 30 or parse various pieces of information from the packet received from the host 30. Also, the buffer memory 360 may temporarily store data to be written to the nonvolatile memory 400 or data to be read from the nonvolatile memory 400. The buffer memory 360 may be provided in the storage controller 300, but may be disposed outside the storage controller 300.

The command process module 330 may include a cache and a processor for processing a firmware image download command or a commit command received from the host 30. The command process module 330 may perform a custom firmware load operation or execution operation based on a firmware image download command or a commit command.

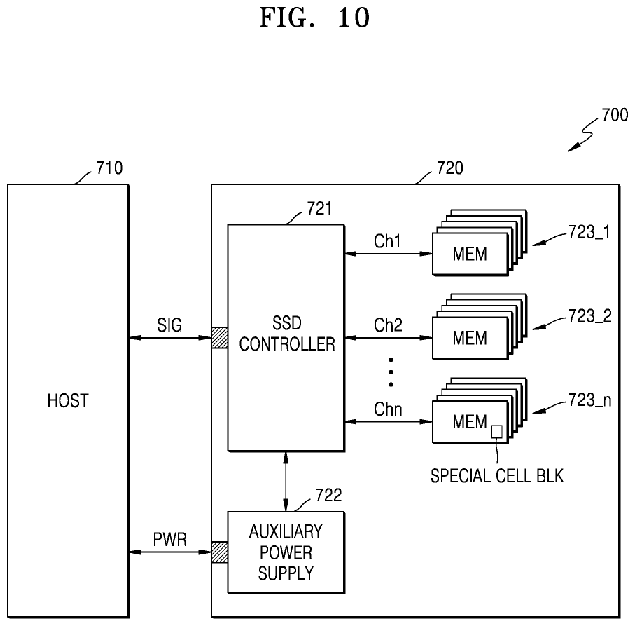

FIG. 10 is a block diagram illustrating an example of applying a memory device according to example embodiments of the inventive concept to an SSD system.

Referring to FIG. 10, an SSD system 700 may include a host 710 and an SSD 720. The SSD 720 exchanges signals with the host 710 through a signal connector, and receives power through a power connector. The SSD 720 may include an SSD controller 721, an auxiliary power supply 722, and memory devices 723_1 to 723_n. The memory devices 723_1 to 723_n may be vertically stacked NAND flash memory devices. In this case, the SSD 720 may be implemented using the embodiments described above with reference to FIGS. 1 to 9. That is, each of the memory devices 723_1 to 723_n included in the SSD 720 may include a plurality of cell blocks, and at least one of the plurality of cell blocks may include an area for storing custom firmware. In addition, the SSD controller 721 may receive custom firmware from an area capable of storing custom firmware, and may load and execute the received custom firmware.

While the inventive concept has been particularly shown and described with reference to embodiments thereof, it will be understood that various changes in form and details may be made therein without departing from the spirit and scope of the following claims.

What is claimed is:

1. A storage device configured to communicate with a host device, the storage device comprising:
at least one nonvolatile memory; and
a memory controller comprising an execution region, the memory controller configured to:
control a firmware load operation of the at least one nonvolatile memory,
receive a commit command from the host device,
load custom firmware, which are configured in a form of an add-on to main firmware, into the execution region, and
execute the custom firmware in the execution region based on the commit command.

2. The storage device of claim 1, wherein the memory controller is further configured to:
receive a firmware image download command from the host device; and
determine whether to store the custom firmware in the at least one nonvolatile memory based on the firmware image download command.

3. The storage device of claim 1, wherein the execution region comprises a first region in which the main firmware is loaded and a second region in which the custom firmware is loaded, and
wherein the second region is separated from the first region.

4. The storage device of claim 1, wherein the execution region comprises a first region in which the main firmware is loaded and a second region in which the custom firmware is loaded,
wherein the first region comprises the second region.

5. The storage device of claim 1, further comprising a buffer memory, which is physically provided inside the storage device,
wherein the memory controller is further configured to:
receive the custom firmware from the buffer memory;
load the custom firmware into the execution region; and
execute the custom firmware in the execution region based on the commit command.

6. The storage device of claim 5, wherein the memory controller is further configured to:
receive a firmware image download command from the host device; and
determine whether to store the custom firmware received from the buffer memory in the at least one nonvolatile memory based on the firmware image download command.

7. The storage device of claim 1, wherein the memory controller is further configured to:
receive the custom firmware from a host buffer memory included in the host device;
load the custom firmware into the execution region; and
execute the custom firmware in the execution region based on the commit command.

8. The storage device of claim 7, wherein the memory controller is further configured to:
receive a firmware image download command from the host device; and
determine whether to store the custom firmware received from the host buffer memory in the nonvolatile memory based on the firmware image download command.

9. The storage device of claim 1, wherein the storage device is configured to communicate with the host device according a predetermined protocol, which comprises at least one of a Non Volatile Memory Express (NVMe) protocol and an NVMe over Fabric protocol.

10. The storage device of claim 1, wherein the custom firmware comprises at least one of dynamic thermal throttling (DTT) firmware, Acceleration firmware, Debug firmware, Test firmware, and Logging firmware.

11. A method of operating a storage device including at least one nonvolatile memory, the method comprising:
verifying a validity of custom firmware based on at least one of a checksum method, a hash function method, an electronic signature method, and a message authentication code (MAC) method;
loading the custom firmware into an execution region based on a verification of the validity of the custom firmware; and
executing the custom firmware loaded in the execution region.

12. The method of claim 11, wherein the loading of the custom firmware into the execution region comprises:
determining whether to store the custom firmware in the nonvolatile memory before loading the custom firmware into the execution region; and
loading the custom firmware from the nonvolatile memory into the execution region after storing the custom firmware in the nonvolatile memory when the custom firmware is stored in the nonvolatile memory.

13. The method of claim 11, wherein the storage device further includes a buffer memory,
wherein the verifying the validity of the custom firmware comprises:
receiving a firmware image download command from a host device according to a protocol;
receiving the custom firmware for the firmware image download command from the buffer memory; and
verifying the custom firmware.

14. The method of claim 11, wherein the verifying the validity of the custom firmware comprises:
receiving a firmware image download command from a host device according to a protocol;
receiving the custom firmware for the firmware image download command from a host buffer memory of the host device; and
verifying the custom firmware.

15. The method of claim 11, wherein the custom firmware comprises at least one of dynamic thermal throttling (DTT) firmware, Acceleration firmware, Debug firmware, Test firmware, and Logging firmware.

16. A host-storage system comprising:
a host device configured to generate a firmware image download command and a commit command; and
a storage device comprising at least one nonvolatile memory,
wherein the storage device is configured to:
receive the firmware image download command from the host device,
determine whether to store custom firmware, which is configured in a form of an add-on to main firmware, in the nonvolatile memory based on the firmware image download command,
receive the commit command from the host device, and
load the custom firmware into an execution region of the storage device.

17. The host-storage system of claim 16, wherein the storage device further comprises a buffer memory, and
wherein the storage device is further configured to receive the custom firmware from the buffer memory.

18. The host-storage system of claim 16, wherein the host device comprises a host buffer memory,
wherein the storage device is further configured to receive the custom firmware from the host buffer memory.

19. The host-storage system of claim 16, wherein the execution region comprises a first region in which the main firmware is loaded and a second region in which the custom firmware is loaded,
wherein the first region comprises the second region.

20. The host-storage system of claim 16, wherein the storage device is configured to communicate with the host device according a Non Volatile Memory Express (NVMe) protocol,
wherein the custom firmware comprises at least one of dynamic thermal throttling (DTT) firmware, Acceleration firmware, Debug firmware, Test firmware, and Logging firmware.
